(19) United States
(12) Patent Application Publication
(10) Pub. No.: US 2024/0305006 A1
(43) Pub. Date: Sep. 12, 2024

(54) Antenna Arrangement

(71) Applicant: Nokia Technologies Oy, Espoo (FI)

(72) Inventors: Harri Arttur Varheenmaa, Helsinki (FI); Pasi Yla-Oijala, Vantaa (FI); Anu Kristiina Lehtovuori, Espoo (FI); Ville Viikari, Espoo (FI)

(21) Appl. No.: 18/596,137

(22) Filed: Mar. 5, 2024

(30) Foreign Application Priority Data
Mar. 9, 2023 (EP) 23160869.6

(51) Int. Cl. H01Q 13/16; H01Q 21/30

(52) U.S. Cl. CPC H01Q 13/16; H01Q 21/30

(57) ABSTRACT

Antenna arrangement including: a feed; and an electrically conductive portion that terminates at an edge, wherein the electrically conductive portion includes a slot including: an elongate first slot-path extending lengthwise from the feed in a first direction; and an elongate second slot-path extending lengthwise from the feed in a second direction different to the first direction, wherein the elongate first slot-path extends lengthwise a first distance in the first direction from the feed and then bifurcates, into an elongate first bifurcated slot path and an elongate second bifurcated slot path, wherein: the elongate first bifurcated slot path is close-ended and terminates at a first closed end; the elongate second bifurcated slot path is open-ended and terminates at an open end in the edge; and the elongate second slot path is close-ended and terminates at a second closed end.

### TECHNOLOGICAL FIELD

Examples of the disclosure relate to an antenna arrangement. Some relate to an antenna arrangement configured to have a wide operational bandwidth.

### BACKGROUND

A wide bandwidth is important in telecommunications because it enables the transfer of more information per second.

It is therefore desirable to design antenna arrangements that have wide (large) operational bandwidths.

### BRIEF SUMMARY

According to various, but not necessarily all, examples there is provided an antenna arrangement comprising:
a feed; and
an electrically conductive portion that terminates at an edge, wherein the electrically conductive portion comprises a slot comprising:
an elongate first slot-path extending lengthwise from the feed in a first direction; and
an elongate second slot-path extending lengthwise from the feed in a second direction different to the first direction,
wherein the elongate first slot-path extends lengthwise a first distance in the first direction from the feed and then bifurcates, into an elongate first bifurcated slot path and an elongate second bifurcated slot path,
wherein:
the elongate first bifurcated slot path is close-ended and terminates at a first closed end;
the elongate second bifurcated slot path is open-ended and terminates at an open end in the edge; and
the elongate second slot path is close-ended and terminates at a second closed end.

In some, but not necessarily all examples, the elongate first bifurcated slot path, the elongate second bifurcated slot path and the elongate second slot path are mutually sized and arranged to provide:
a lower frequency resonance having a lower frequency operational bandwidth;
a higher frequency resonance having a higher frequency operational bandwidth; and
an intermediate frequency resonance having an intermediate frequency operational bandwidth, wherein the lower frequency operational bandwidth and the higher frequency operational bandwidth are interconnected by the intermediate frequency operational bandwidth to form a combined bandwidth.

In some, but not necessarily all examples, the lower frequency resonance is a half wavelength resonant mode enabled by the open end of elongate second bifurcated slot path, the higher frequency resonance is a full wavelength resonant mode and the intermediate frequency resonance is an even resonance mode.

In some, but not necessarily all examples, at least a length of the elongate first bifurcated slot path and a length of the second slot path are sized and arranged to provide the lower frequency resonance, the higher frequency resonance and the intermediate frequency resonance.

In some, but not necessarily all examples, the feed is a single broadband feed configured to feed across the combined bandwidth.

In some, but not necessarily all examples, the first closed end is positioned further from the feed than the open end and wherein the open end is positioned further from the feed than the second closed end.

In some, but not necessarily all examples, the elongate first slot path including the close-ended elongate first bifurcated slot path, the open-ended elongate second bifurcated slot path and the close-ended elongate second slot-path lie in one or more parallel planes.

In some, but not necessarily all examples, the parallel plane is substantially perpendicular to an electrically conductive ground plane.

In some, but not necessarily all examples, the slot comprises only the elongate first slot-path extending lengthwise from the feed in a first direction and the elongate second slot-path extending lengthwise from the feed in a second direction different to the first direction, and wherein the elongate first slot-path comprises only the elongate first bifurcated slot path and the elongate second bifurcated slot path, wherein the elongate first bifurcated slot path has only a single end that is close-ended, the elongate second bifurcated slot path has only a single end that is open-ended and the elongate second slot path has only a single end that is close-ended.

In some, but not necessarily all examples, the elongate first bifurcated slot path and the elongate second bifurcated slot path and the elongate second slot path occupy a slot area in a common plane and are formed in electrically conductive portions also in the common plane wherein the areas of the electrically conductive portions in the common plane are greater than the slot area.

In some, but not necessarily all examples, wherein a first continuous planar electrically conductive portion defines the elongate first bifurcated slot path,
a second continuous planar electrically conductive portion defines the elongate second slot path and a
a space between the first continuous planar electrically conductive portion and the second continuous planar electrically conductive portion defines the elongate second bifurcated slot path.

In some, but not necessarily all examples, the electrically conductive portion is a rim of an apparatus.

In some, but not necessarily all examples, the rim extends upwardly from a ground plane and the elongate second bifurcated slot path terminates at an open end, on an edge or rim furthest from the ground plane.

In some, but not necessarily all examples, there is no portion of the rim between the elongate first slot path, before bifurcation, and the ground plane.

In some, but not necessarily all examples, wherein the elongate first bifurcated slot path comprises an initial portion that extends in the first direction and a terminating portion that extends in a third direction perpendicular to the first direction and terminates at the closed end,
the elongate second bifurcated slot path comprises a terminating portion that extends in a third direction perpendicular to the first direction and terminates the open end, and
the elongate second slot-path comprises a portion extending in the third direction perpendicular to the first direction and a terminating portion that extends in the first direction and terminates at the closed end.

In some, but not necessarily all examples, the elongate second slot path is positioned and shaped so that the second closed end of the elongate second slot path is positioned adjacent the elongate second bifurcated slot path.

In some, but not necessarily all examples, the elongate first slot-path has a F-shape and wherein the elongate second slot-path has a J-shape or an L-shape, wherein the F-shape comprises two parallel arms extending perpendicularly from a stem, wherein a first arm is provided by the elongate first bifurcated slot path and a second arm is provided by the elongate second bifurcated slot path, wherein the second arm is positioned between the first arm and the elongate second slot-path has a J-shape or an L-shape.

According to various, but not necessarily all, examples there is provided an apparatus comprising: an electrically conductive rim;
multiple antenna arrangements as described, defined in the electrically conductive rim.

In some, but not necessarily all examples, the multiple antenna arrangements are of the same size.

In some, but not necessarily all examples, the rim has a substantially planar perimeter formed as a rectangle that has 180 degree rotation symmetry, wherein the multiple antenna arrangements are arranged in the rim to satisfy the same 180 degree rotation symmetry.

In some, but not necessarily all examples, the rim has a spatially distributed array of antenna arrangements wherein each antenna arrangement provides a wideband antenna suitable for multiple-input multiple-output (MIMO).

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

Example antenna arrangements have wide (large) operational bandwidths. The total number of antennas in mobile device is smaller if one antenna covers several bands. Also, a compact size of the antenna arrangement enables high order MIMO.

### BRIEF DESCRIPTION

Some examples will now be described with reference to the accompanying drawings in which:

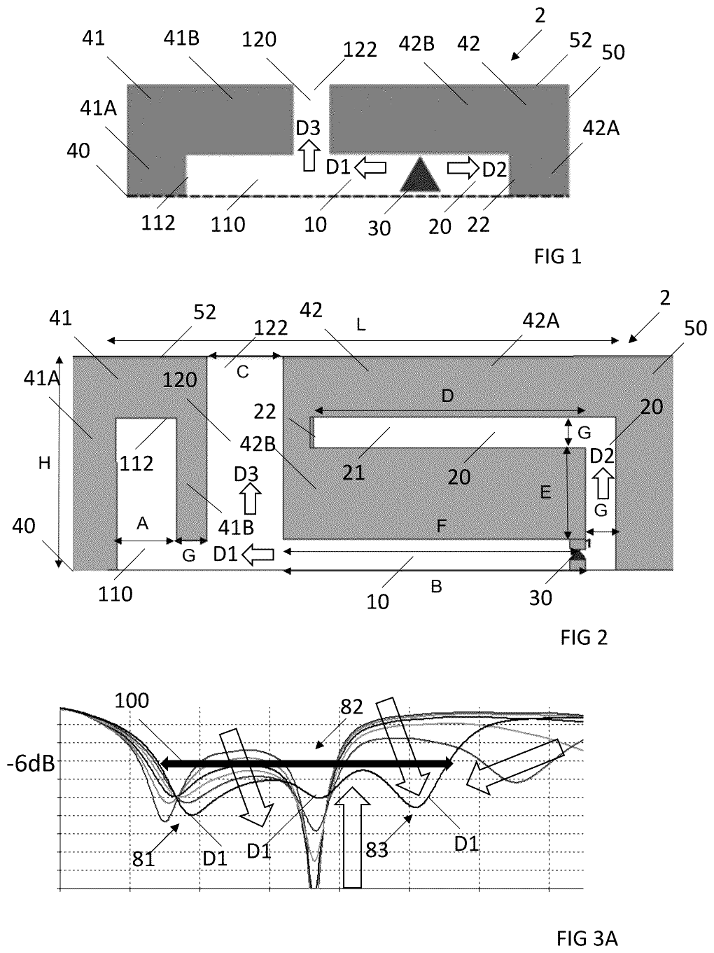

FIG. 1 shows an example of the subject matter described herein;

FIG. 2 shows another example of the subject matter described herein;

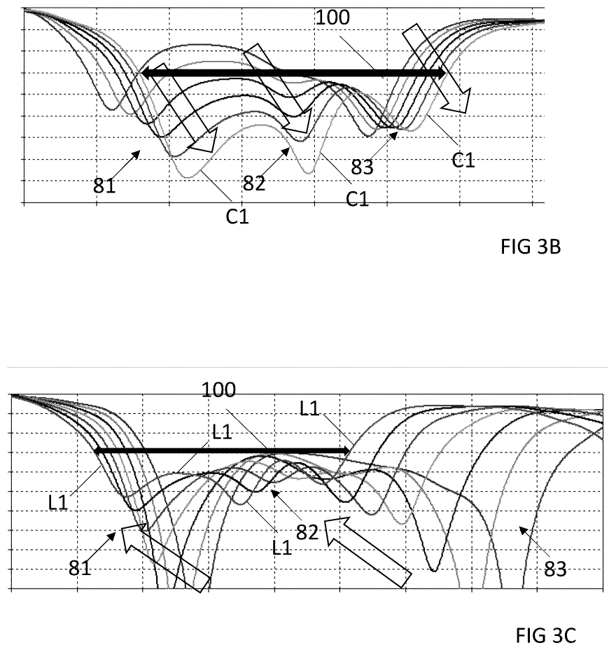

FIG. 3A shows another example of the subject matter described herein;

FIG. 3B shows another example of the subject matter described herein;

FIG. 3C shows another example of the subject matter described herein;

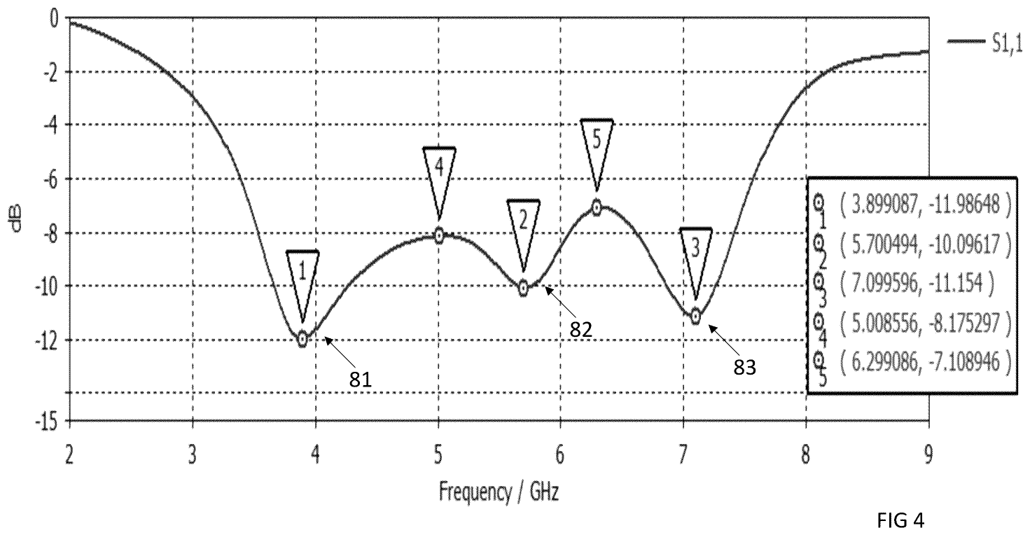

FIG. 4 shows another example of the subject matter described herein;

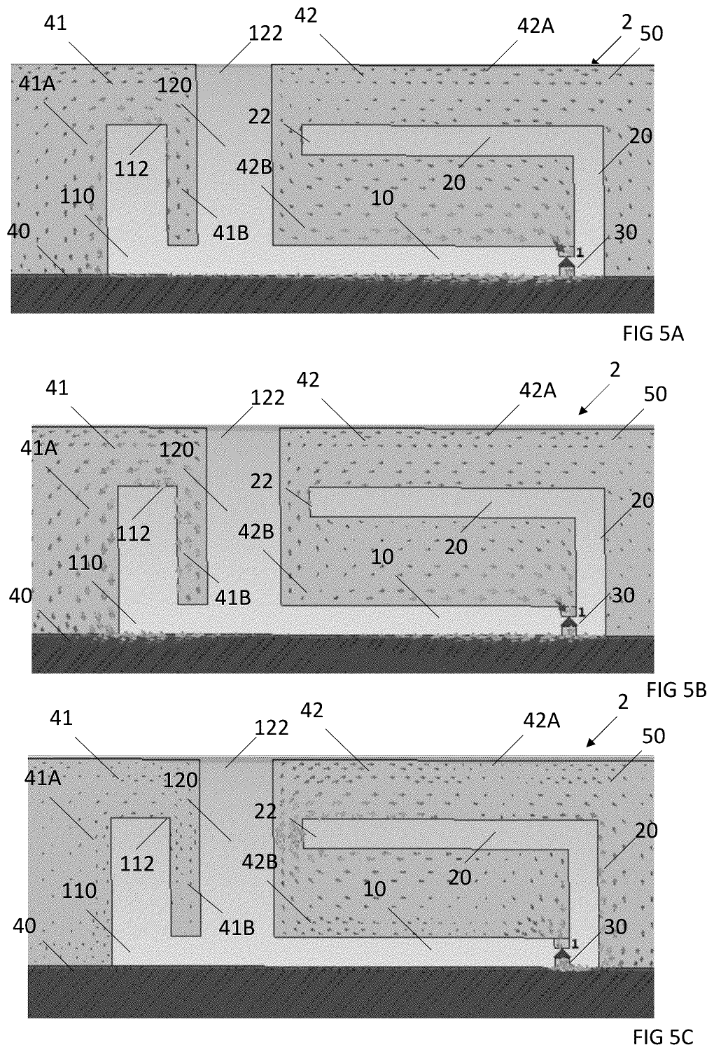

FIGS. 5A, 5B, 5C show another example of the subject matter described herein;

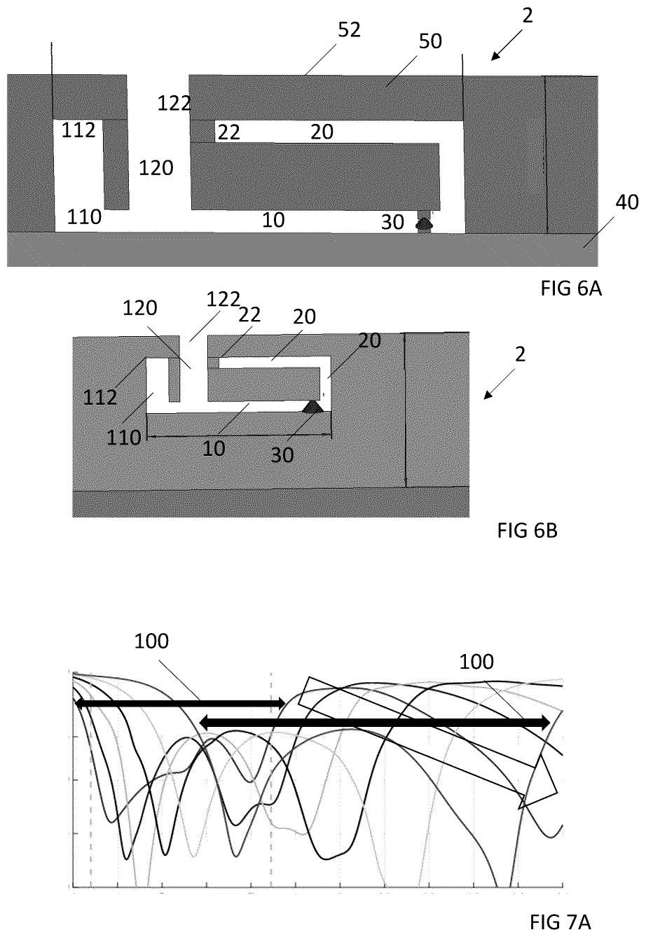

FIGS. 6A, 6B shows other examples of the subject matter described herein;

FIGS. 7A, 7B show other examples of the subject matter described herein;

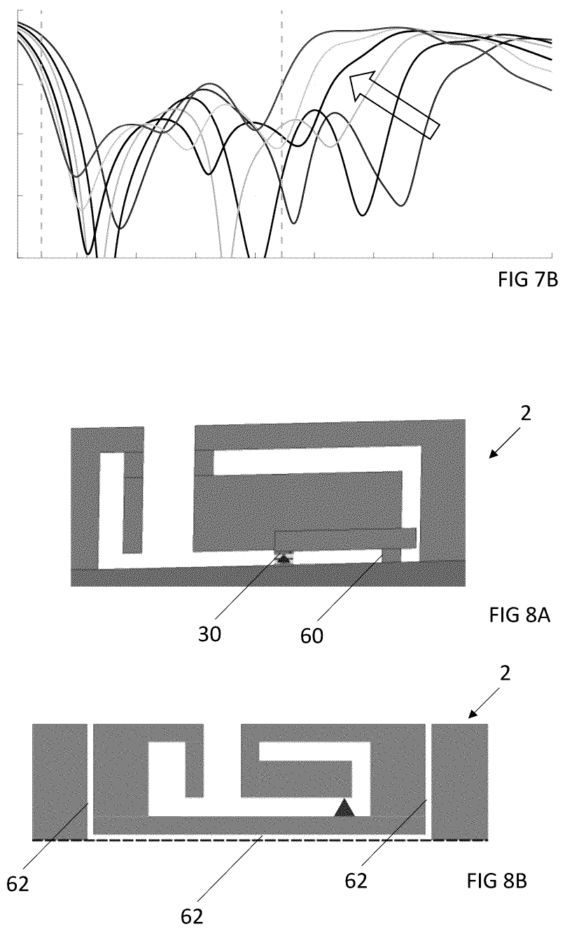

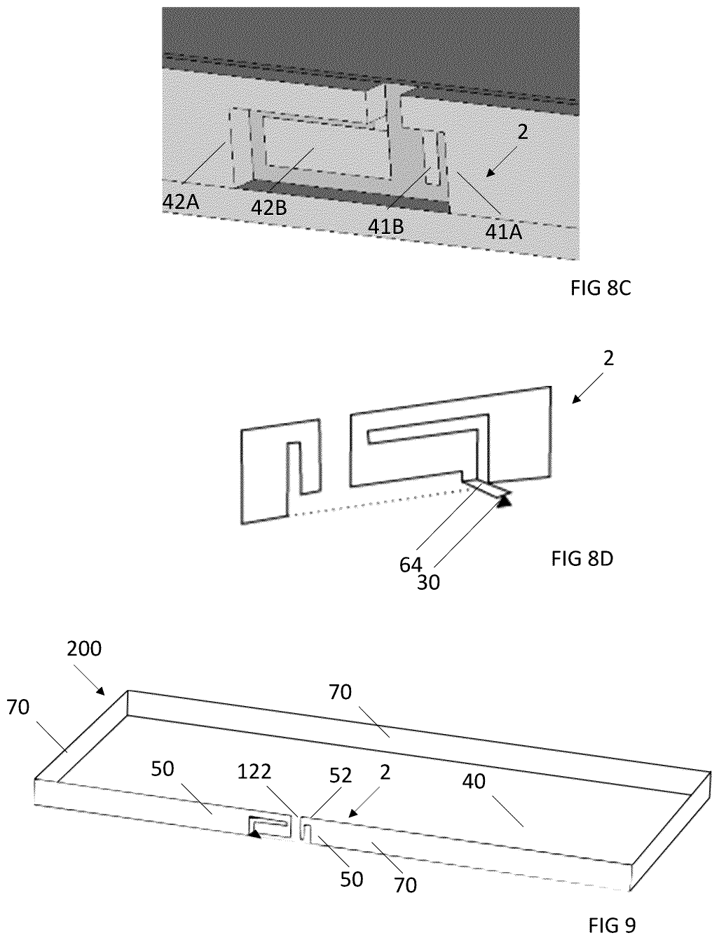

FIGS. 8A, 8B, 8C, 8D show other examples of the subject matter described herein;

FIG. 9 shows another example of the subject matter described herein;

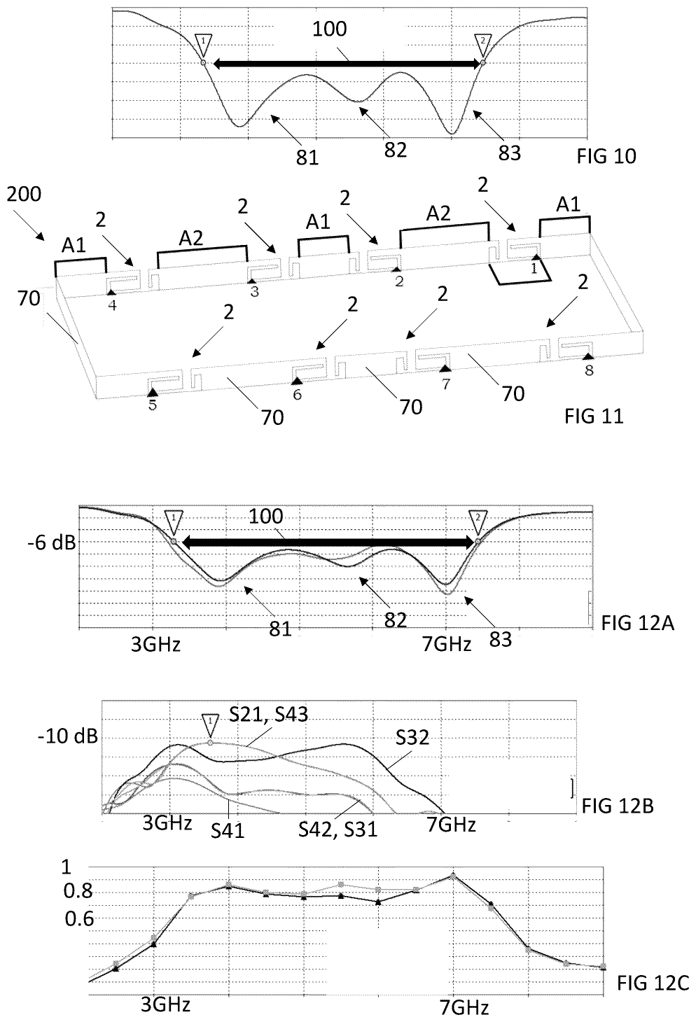

FIG. 10 shows another example of the subject matter described herein;

FIG. 11 shows another example of the subject matter described herein;

FIGS. 12A, 12B, 12C show other example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

The FIGs, including FIG. 1 and FIG. 2, illustrate different examples of an antenna arrangement 2 comprising:
a feed 30;
electrically conductive portion 50 that terminates at an edge 52, wherein the electrically conductive portion 50 comprises a slot comprising:
an elongate first slot-path 10 extending lengthwise from the feed 30 in a first direction D1;
an elongate second slot-path 20 extending lengthwise from the feed 30 in a second direction D2 different to the first direction D1,
wherein the elongate first slot-path 10 extends lengthwise a first distance in the first direction D1 from the feed 30 and then bifurcates, into an elongate first bifurcated slot path 110 and an elongate second bifurcated slot path 120,
wherein
the elongate first bifurcated slot path 110 is close-ended and terminates at a first closed end 112;
the elongate second bifurcated slot path 120 is open-ended and terminates at an open end 122 in
the edge 52; and
the elongate second slot path 20 is close-ended and terminates at a second closed end 22.

The antenna arrangement 2 excites multiple resonant modes with overlapping frequency bands which provides wideband operation. As illustrated in FIGS. 3A, 3B, 3C, 4, 7A, 7B, 10, 12A a lower frequency resonance 81 has a lower frequency operational bandwidth, a higher frequency resonance 83 has a higher frequency operational bandwidth, and an intermediate frequency resonance 82 has an intermediate frequency operational bandwidth that is between, and overlaps, the lower frequency operational bandwidth and the higher frequency operational bandwidth.

A slot-path is a portion of a slot that extends lengthwise and has a width. An elongate slot-path has a length that is multiple times larger than its width. A slot-path has a closed end if the slot in conductive material is terminated by conductive material. A slot-path has an open end if the slot in conductive material is terminated by dielectric, for example an air gap.

In this document the term slot is used to refer to an elongate absence of material from an element. A slot is an example of an aperture. A slot can branch one or more times. A slot can have an open end or a closed end. In some examples slots have parallel sides but this need not always be the case. In this document the term aperture is used to refer to a conduit that extends completely through an element. An aperture can be fully or partially surrounded by the element. An aperture that is fully surrounded (enclosed) by the element can be described as a via or a through-hole. The aperture can be filled by a different material.

Referring to FIGS. 1 and 2, for example, the first closed end 112 is positioned further from the feed 30 than the open end 122. The open end 122 is positioned further from the feed 30 than the second closed end 22.

The elongate first slot path 10 including the close-ended elongate first bifurcated slot path 110 and the open-ended elongate second bifurcated slot path 120, and the close-ended elongate second slot path 20 lie in one or more parallel planes. The parallel planes can be flat planes or curved planes.

The one or more parallel planes are perpendicular or substantially perpendicular to an electrically conductive ground plane 40.

In the specific examples illustrated, the electrically conductive portion 50 is planar forming a two-dimensional flat plane. The elongate first slot path 10, including the elongate first bifurcated slot path 110 and elongate second bifurcated slot path 120, and the elongate second slot path 20 are in the same two-dimensional flat plane.

In the illustrated examples, but not necessarily all examples, the slot consists of only the elongate first slot path 10 extending lengthwise from the feed 30 in a first direction D1 and the elongate second slot path 120 extending lengthwise from the feed 30 in a second direction D2 different to the first direction D1. The elongate first slot path 10 consists of only the elongate first bifurcated slot path 110 and the elongate second bifurcated slot path 120. The elongate first bifurcated slot path 110 has only a single end 112 that is close-ended. The elongate second bifurcated slot path 120 has only a single end 122 that is open-ended. The elongate second slot path 20 has only a single end 22 that is close-ended.

The elongate first bifurcated slot path 110 and the elongate second bifurcated slot path 120 and the elongate second slot path 20 occupy a slot area in a common plane and are formed in electrically conductive portions 41, 42 also in the common plane. The areas of the electrically conductive portions 41, 42 in the common plane is greater than the slot area.

The common plane is a two-dimensional plane that extends in the first direction D1 and the second direction D2 and in a third direction D3 perpendicular to the first direction D1. In the example illustrated the two-dimensional plane is a flat two-dimensional plane.

The conductive material used to form the electrically conductive portion 50 or portions 41, 42 has a thickness. Therefore despite occupying the common plane they have a three-dimensional aspect.

In the example illustrated, but not necessarily all examples, a first continuous planar electrically conductive portion 41 defines the elongate first bifurcated slot path 110. A second continuous planar electrically conductive portion 42 defines the elongate second slot path 20. A space between the first continuous planar electrically conductive portion 41 and the second continuous planar electrically conductive portion 42 defines the elongate second bifurcated slot path 120.

In the example illustrated, but not necessarily all examples, the first continuous electrically conductive portion 41 extends in a third direction D3, perpendicular to the first direction D1, a distance greater than a greatest width of the slot. The second continuous electrically conductive portion 42 extends in the third direction D3, perpendicular to the first direction D1, a distance greater than the greatest width of the slot.

In the example illustrated, but not necessarily all examples, the electrically conductive portion 50 comprises a first portion 41A, a second portion 41B, a third portion 42B, and a fourth portion 42A. The elongate first slot path 10 is adjacent the first portion 41A, second portion 41B and the third portion 42B but not adjacent the fourth portion 42A. The elongate second slot path 20 is adjacent the third portion 42B and the fourth portion 42A but not adjacent the first portion 41A and not adjacent the second portion 41B. The elongate first bifurcated slot path 110 is adjacent the first portion 41A and the second portion 41B but not adjacent the third portion 42B and not adjacent the fourth portion 42A. The elongate second bifurcated slot path 120 is adjacent the second portion 41B and the third portion 42B but not adjacent the first portion 41A and not adjacent the fourth portion 42A. The first and second portions 41A, 41B interconnect adjacent the closed end 112 of the elongate first bifurcated slot path 110. The third and fourth portions 42B, 42A interconnect adjacent the closed end 22 of the elongate second slot path 20. The second portion 41B and the third portion 42B are separated by the open end 122 of the second bifurcated slot path 120.

In the examples illustrated, but not necessarily all examples, the elongate first slot path 10, before bifurcation, extends parallel to ground plane 40. The elongate first slot path 10 is straight before bifurcation. The majority of the elongate first slot path 10 extends parallel to ground plane 40.

In the examples illustrated in FIGS. 1 & 2, but not necessarily all examples, at least a portion of the elongate first slot-path 10 is directly adjacent a ground plane 40, without any intervening conductive material between the elongate first slot-path 10 and the ground plane 40. This portion of the elongate first slot-path 10 has zero-clearance with respect to the ground plane 40. At least a portion of the elongate second slot-path 10 is directly adjacent the ground plane 40, without any intervening conductive material between the elongate second slot-path 10 and the ground plane 40. This portion of the elongate second slot-path 10 has zero-clearance with respect to the ground plane 40.

The antenna arrangement 2 comprises a feed 30 that is shared by the elongate first slot-path 10 and the elongate second slot-path 20.

In FIG. 1, the slot in the electrically conductive portion 50 comprises an ‘open T-slot’ and a ‘closed I-slot’. The elongate first slot-path 10 provides the ‘open T-slot. The elongate second slot-path 20 provides the ‘closed I-slot’. The elongate first slot-path 10, before bifurcation, is aligned with the close-ended elongate first bifurcated slot path 110 and is perpendicular to the open-ended elongate second bifurcated slot path 120. The elongate first slot-path 10, before bifurcation, is also aligned with the close-ended elongate second slot path 20. The slot therefore has an asymmetric ‘T-shape’.

In FIG. 2, the antenna arrangement is compact and comprises bent slots 10, 20.

The elongate first bifurcated slot path 110 comprises an initial portion that extends in the first direction D1 and a terminating portion that extends in a third direction D3 perpendicular to the first direction D1 and terminates at the closed end 112.

The elongate second bifurcated slot path 120 comprises a terminating portion that extends in a third direction D3 perpendicular to the first direction D1 and terminates at the open end 122.

The elongate second slot path 20 comprises a portion extending in the third direction D3 perpendicular to the first direction D1 and a terminating portion 21 that extends in the first direction D1 and terminates at the closed end 22.

The terminating portion of the elongate second slot path 20 extends parallel to and is separated from the initial portion of the elongate first slot path 10, before bifurcation.

The elongate second slot path 20 is positioned and shaped so that second closed end 22 of the elongate second slot path 20 is positioned adjacent (but separated from) the elongate second bifurcated slot path 120.

A terminating portion 21 of the elongate second slot path 20 that terminates at the second closed end 22 extends in the first direction D1 towards a proximal portion of the elongate second bifurcated slot path 120. The proximal portion of the elongate second bifurcated slot path 120 extends in a third direction D3 perpendicular to the first direction D1.

The elongate first bifurcated slot path 110 comprises a right-angle path from the point of bifurcation. The elongate second bifurcated slot path 120 comprises a straight path from the point of bifurcation.

The terminating portion of the elongate first bifurcated slot path 110 extends parallel to, but separated from the elongate second bifurcated slot path 120. The portion of the elongate first bifurcated slot path 110 that extends from the point of bifurcation to the right-angle bend (to the terminating portion of the elongate first bifurcated slot path 110) is aligned with the portion of the elongate first slot path 10 before bifurcation.

The elongate second slot path 20 comprises a straight path that is parallel to the elongate second bifurcated slot path 120 and a straight path terminating portion 21 that extends parallel to the portion of the elongate first slot path 10 before bifurcation. The terminating portion 21 approaches close to but does not touch the elongate second slot path 120.

In at least some examples, the elongate first slot path 10 has a F-shape and the elongate second slot-path 20 has a J-shape or an L-shape. In FIG. 2, the slot in the electrically conductive portion 50 comprises an ‘open F-slot’ and a ‘closed J slot’. The elongate first slot-path 10 provides the ‘open F-slot’. The elongate second slot-path 20 provides the ‘closed J slot’.

The F-shape comprises two parallel arms extending perpendicularly from a stem, wherein a first arm is provided by the elongate first bifurcated slot path 110 and a second arm is provided by the elongate second bifurcated slot path 120, and a portion of the stem is provided by the initial portion of the first slot path 10 before bifurcation. The second arm is positioned between the first arm and the elongate second slot-path 20 that has a J-shape or an L-shape.

The example of the antenna arrangement 2, illustrated in FIG. 2, is an FJ-Slot Antenna. The antenna arrangement 2, consists of two slots, an open F-shaped slot 10 and a closed J-shaped slot 20, connected by a feed 30.

The elongate first slot-path 10 which splits into the close-ended elongate first bifurcated slot path 110 and the open-ended elongate second bifurcated slot path 120 provides the open F-shaped slot. The elongate close-ended second slot-path 20 provides the closed J-shaped slot 20.

As illustrated later (FIG. 9) in at least some examples the ground plane 40 is untouched and uniform and does not comprise any slots.

Example lengths of the dimensions A, B, C, D, E, F, G, H, L illustrated in FIG. 2 are: A=2.0 mm, B=11 mm, C=2.5 mm, D=9.0 mm, E=3.0 mm, F=9.5 mm, G=1.0 mm, H=7.0 mm, L=16.5 mm. The antenna arrangement 2 occupies an area of L×H (16.5 mm×7 mm)

The elongate first bifurcated slot path 110, the elongate second bifurcated slot path 120 and the elongate second slot path 20 are mutually sized and arranged to provide:
a lower frequency resonance 81 having a lower frequency operational bandwidth;
a higher frequency resonance 83 having a higher frequency operational bandwidth; and an intermediate frequency resonance 82 having an intermediate frequency operational bandwidth, wherein the lower frequency operational bandwidth and the higher frequency operational bandwidth are interconnected by the intermediate frequency operational bandwidth to form a combined operational bandwidth 100.

Examples of a lower frequency resonance 81 having a lower frequency operational bandwidth, a higher frequency resonance 83 having a higher frequency operational bandwidth, an intermediate frequency resonance 82 having an intermediate frequency operational bandwidth, and a combined operational bandwidth 100 are illustrated in FIG. 3A.

The lower frequency resonance 81 is an odd resonant mode (a half wavelength resonant mode) enabled by the open end 122 of elongate second bifurcated slot path 120.

The higher frequency resonance 83 is an even resonance mode (a full wavelength resonant mode) and the intermediate frequency resonance 82 is an even resonance mode (a full wavelength resonant mode).

The boundary conditions provided by the open end 122 of the elongate second bifurcated slot path 120 enable the lower frequency resonance 81 (half wavelength resonance).

At least a length of the elongate first bifurcated slot path 110 and a length of the second slot path 20 are sized and arranged to provide the lower frequency resonance, the higher frequency resonance and the intermediate frequency resonance.

The feed 30 is a single broadband feed 30 configured to feed 30 across the combined bandwidth 100.

In the examples of FIGS. 1 and 2 and in other examples described, the electrically conductive portion 50 can be a metal portion. The electrically conductive portion 41 can be a metal portion. The electrically conductive portion 42 can be a metal portion. Some or all of the first portion 41A, second portion 41B, third portion 42B, and fourth portion 42A can be a metal portion.

The electrically conductive ground plane 40 can be a metal ground plane.

FIG. 3A illustrates the three resonant modes and how they vary with increasing a length D (a length of the terminating portion 21 of the second path length 20) as illustrated in FIG. 2. FIG. 3A plots the S11 parameter against frequency. As D increases the highest frequency resonant mode reduces in frequency and the damping associated with the lowest frequency resonant mode and the intermediate frequency resonant mode increases (the associated Q-factor decreases). The S11 parameter for D=D1 has a wide operational bandwidth 100.

FIG. 3B illustrates the three resonant modes and how they vary with increasing a slot width length C (the width of the elongate second bifurcated slot path 120) as illustrated in FIG. 2. This is the width of the open-ended slot. FIG. 3B plots the S11 parameter against frequency. As C increases the highest and lowest frequency resonant modes increase in frequency and the intermediate frequency resonant mode develops and overlaps with the lowest frequency resonant mode to produce a wide operational bandwidth 100. The largest value of C is labelled C1.

FIG. 3C illustrates the three resonant modes and how they vary with increasing the dimension L (maximum lateral extent of the antenna arrangement 2) as illustrated in FIG. 2. This is the maximum lateral extent to the antenna arrangement 2. FIG. 3C plots the S11 parameter against frequency. As L increases the bandwidth 100 remains wide and shifts to a lower frequency. The variation of L provides an option to shift the wide operational frequency band up and down the frequency spectrum. The largest value of L is labelled L1.

A wide operational bandwidth 100 can, for example, be 3.4 GHz to 7.4 GHz.

FIG. 4 plots the S11 parameter against frequency. It can be observed that there are three resonances 81, 82, 83 at markers 1, 2 and 3. These resonances are due to the slots. FIG. 5A illustrates the electric current distribution for the lowest frequency resonance 81. FIG. 5B illustrates the electric current distribution for the intermediate frequency resonance 82. FIG. 5C illustrates the electric current distribution for the highest frequency resonance 83.

The lowest frequency resonance 81 (FIG. 5A) corresponds to a half-wavelength resonance associated with the close-ended elongate first bifurcated slot path 110.

The intermediate frequency resonance 82 (FIG. 5B) corresponds to a full wavelength resonance associated with the close-ended elongate first bifurcated slot path 110.

The high frequency resonance 83 (FIG. 5C) corresponds to a full wavelength resonance associated with the close-ended elongate second slot path 20.

In the examples illustrated the lower frequency odd resonant mode of the F-slot strongly influences the lowest frequency resonant mode of the antenna arrangement 2; the higher-frequency even resonant mode of the F-slot strongly influences the intermediate frequency resonant mode of the antenna arrangement 2 and the even resonant mode of the J-slot strongly influences the highest frequency resonant mode of the antenna arrangement 2.

Some important physical dimensions are therefore:
a length of a current path around a perimeter of the second slot path 20 (e.g. J slot);
a length of a current path around a perimeter of the close-ended elongate first bifurcated slot path 110.

Another physical dimensions that has an impact on coupling between the second slot path 20 (J slot) and the open-ended elongate second bifurcated slot path 120 (open-F slot) is the distance between the closed end 22 of the second slot path 20 (J slot) and the elongate second bifurcated slot path 120 (open-F slot).

FIGS. 6A, 6B, 7A illustrate how the antenna arrangement 2 can be scaled relative to a size of the electrically conductive portion 50. In FIG. 6A a height H of the antenna arrangement 2 is the same as a distance between the edge 52 of the electrically conductive portion 50 and the ground plane 40. There is zero clearance between the slot and the ground plane 40. In FIG. 6B a height H of the antenna arrangement 2 is significantly less than a distance between the edge 52 of the electrically conductive portion 50 and the ground plane 40. There is clearance between the slot and the ground plane 40.

In FIG. 7A the S11 parameter is plotted against frequency for different scaling factors k.

The effect of scaling the antenna arrangement by a scaling factor k is illustrated.

For example, all dimensions A, B, C, D, E, F, G, H, L are multiplied by the same scaling factor k.

As the size of the antenna arrangement decreases (indicated by the arrow in the FIG), electrical lengths decrease and the frequencies of the combined operational bandwidth 100 increase.

The antenna arrangement 2 can be scaled to a wanted frequency range by scaling its size.

In FIG. 7B the S11 parameter is plotted against frequency for different values of dielectric permittivity associated with the slot. This illustrates the effect of dielectric loading at the slot.

The effect of changing the dielectric permittivity is illustrated. As the size of the dielectric permittivity increases (indicated by the arrow in the FIG), electrical lengths increase and the frequencies of the combined operational bandwidth 100 decrease.

FIGS. 8A-8D illustrate alternative antenna arrangements 2. For clarity of illustration the features in these FIGs which are the same as those illustrated in FIG. 2 are not labelled—the features of difference are labelled.

The antenna arrangements 2 comprise:
a feed 30;
electrically conductive portion 50 that terminates at an edge 52, wherein the electrically conductive portion 50 comprises a slot comprising:
an elongate first slot-path 10 extending lengthwise from the feed 30 in a first direction D1;
an elongate second slot-path 20 extending lengthwise from the feed 30 in a second direction D2 different to the first direction D1,
wherein the elongate first slot-path 10 extends lengthwise a first distance in the first direction D1 from the feed 30 and then bifurcates, into an elongate first bifurcated slot path 110 and an elongate second bifurcated slot path 120,
wherein
the elongate first bifurcated slot path 110 is close-ended and terminates at a first closed end 112;
the elongate second bifurcated slot path 120 is open-ended and terminates at an open end 122 in the edge 52; and
the elongate second slot path 20 is close-ended and terminates at a second closed end 22.

FIG. 8A illustrates an alternative feed 30. In some examples, as illustrated in FIG. 2, the feed 30 is a galvanic feed, in other words a feed which is capable of conveying (but is not necessarily used to convey) a direct current (DC). A galvanic feed comprises a physical connection between conducting parts. In this example, the feed 30 is a capacitive feed, in other words a feed which is capable of coupling electric fields across a non-galvanic (dielectric) gap between two conductors.

The capacitive feed 30 comprises a capacitive element 60 for coupling to the slot.

FIG. 8B illustrates a floating antenna arrangement 2. A slot 62 surrounds the antenna arrangement 2.

FIG. 8C illustrates a three-dimensional antenna arrangement 2. The electrically conductive portion 50 is formed on different planes. For example, the portions 41A, 42A are formed in one plane and the portions 41B, 42B are formed in a different parallel plane.

In other examples (not illustrated), the elongate first slot path 10, including the elongate first bifurcated slot path 110 and elongate second bifurcated slot path 120, are in a first plane and the elongate second slot path 20 is in a different second plane that is parallel to the first plane.

FIG. 8D illustrates a single-slot antenna arrangement 2 where the elongate first slot 10 and the elongate second slot 20 form a single continuous slot in a single plane. The feed 30 is positioned in a different parallel plane and a feeding structure 64 provides coupling of the feed 30 to the slot.

In this example, the feedline 64 is galvanically connected to the rim 50.

FIG. 9 illustrates an apparatus 200 comprising a electrically conductive rim 70.

In this and other example, the electrically conductive rim 70 can be a metal rim.

At least one antenna arrangement 2, as previously described is defined in the electrically conductive rim 70.

The electrically conductive portion 50 of the antenna arrangement 2 are formed from the electrically conductive rim 70.

The rim 70 extends upwardly, perpendicularly, from a ground plane 40. The rim 70 and ground plane 40 are galvanically connected (except where there is a zero ground-clearance slot).

The elongate second bifurcated slot path 120 terminates at an open end 122, on the edge 52 of the rim furthest from ground plane 40.

In this example there is no portion of the rim 70 between the elongate first slot path 10, before bifurcation, and ground plane 40. There is zero-clearance.

In this example, the ground plane 40 is continuous and uniform. There are no slots defined in the ground plane 40.

The ground plane 40 may be smaller than as shown in FIG. 9 and may be substantially smaller and provided either as a solid piece of metal and/or at least a portion of a layer of a printed circuit board (PCB).

The ground plane 40 may be comprised of multiple smaller ground planes, some or all of which can be provided as a solid piece of metal or a portion of a layer of a printed circuit board (PCB).

The multiple smaller ground planes can be used for a common radio system or for different radio systems.

FIG. 10. Illustrates a plot of S11 parameter against frequency for the antenna arrangement 2 illustrated in FIG. 9.

The antenna arrangement 2 excites multiple resonant modes with overlapping frequency bands which provides wideband operation. A lower frequency resonance 81 that has a lower frequency operational bandwidth, overlaps an intermediate frequency resonance 82 that has an intermediate frequency operational bandwidth. The intermediate frequency resonance 82 that has an intermediate frequency operational bandwidth overlaps a higher frequency resonance 83 that has a higher frequency operational bandwidth.

The lower frequency operational bandwidth, the intermediate frequency operational bandwidth and the higher frequency operational bandwidth overlap to form a combined operational bandwidth 100.

The lower frequency marker [1] is −6 dB at 3.34 GHz. The higher frequency marker [2] is −6 dB at 7.46 GHz. Marker [1] and marker [2] define the combined operational bandwidth 100.

FIG. 11 illustrates an apparatus 200 comprising a electrically conductive rim 70. It is similar to FIG. 9. In this and other example, the electrically conductive rim 70 can be a metal rim.

However, in this example, multiple antenna arrangements 2, as previously described are defined in the electrically conductive rim 70. The electrically conductive portions 50 of each of the antenna arrangements 2 are formed from the electrically conductive rim 70.

The rim 70 extends upwardly, perpendicularly, from a ground plane 40. Each elongate second bifurcated slot path 120 terminates at an open end 122, on the edge 52 of the rim furthest from ground plane 40.

In this example there is no portion of the rim 70 between the elongate first slot paths 10, before bifurcation, and ground plane 40. There is zero-clearance.

In this example, but not necessarily all examples, the ground plane 40 is continuous and uniform. There are no slots defined in the ground plane 40. In other example, there are one or more slots in the ground plane 40 and/or the rim 70 in order to provide access to one or more functional components e.g. camera lens, speaker, microphone, button, etc. It may be possible to use one or more of the slot antenna slots 10, 20 to provide access to one or more functional components e.g. camera lens, speaker, microphone, button, etc.

In this example, the multiple antenna arrangements are of the same size and operate in the same bandwidth.

In this example, the rim 70 forms a substantially rectangular enclosure. The rectangle of the enclosure has 180 degree rotational symmetry about a rotation axis that is perpendicular to the plane of the rectangle and passes through a centroid of the rectangle. The arrangement of the multiple antenna arrangements 2 shares the same 180 degree rotation symmetry about the same rotation axis.

In the example, a first side of the rim has reflection symmetry at a mid point of that side.

A first group of antenna arrangements 2 on a first side of the midpoint has a first handedness (chirality) and a second group of antenna arrangements 2 on a second side of the midpoint has a second, different handedness (chirality).

A second side of the rim, opposing the first side, has reflection symmetry at a mid point of that side. A first group of antenna arrangements 2 on a first side of the midpoint has a first handedness (chirality) and a second group of antenna arrangements 2 on a second side of the midpoint has a second, different handedness (chirality).

The first group of antenna arrangements 2 of the first side of the rim oppose the second group of antenna arrangements 2 of the second side of the rim. The second group of antenna arrangements 2 of the first side of the rim oppose the first group of antenna arrangements 2 of the second side of the rim.

The central antenna arrangements 2 on each of the opposing sides are in a so-called face-to-face configuration, where the F-slots are adjacent. In FIG. 11, the central antenna arrangements 2 are separated by distance A1.

Each central antenna arrangement and its peripherally adjacent antenna arrangement 2 are in a so-called back-to-face configuration, where the J-slot of the central antenna arrangement 2 is adjacent the F-slot of the peripherally adjacent antenna arrangement 2. In FIG. 11, the central antenna arrangement 2 and the peripherally adjacent antenna arrangement are separated by distance A2.

Adjacent antenna arrangements 2 can have three different configurations: back-to-back (J-slot to J-slot), face-to-face (F-slot to F-slot), or back-to-face (F-slot to J-slot or J-slot to F-slot).

The coupling at 7.4 GHz is relatively low for the face-to-face and back-to-face configurations and relatively higher for the back-to-back configuration.

The spatially distributed array of multiple antenna arrangements 2 is suitable for multiple-input multiple-output (MIMO). Each antenna arrangement 2 provides a wideband antenna suitable for multiple-input multiple-output (MIMO).

In the illustrated example, there are 8 antenna arrangements 2 in the array. In other examples there may be more or less. For example, there may be 2\hat{ }n, where n>1.

Due to the compact size, it is possible to place several antenna arrangements into the electrically conductive rim 70.

The distances (in mm) between the antenna elements are marked to the figure. A1=15.0 mm and A2=24.5 mm.

FIG. 12A illustrates the (reflection) S-parameters S11, S22, S33, S44 for the apparatus 200 illustrated in FIG. 11. The operational bandwidth 100 of the MIMO antenna is from 3.3 GHz to 7.4 GHz. FIG. 12B illustrates the (transmission) S-parameters S21, S31, S41, S32, S34, S43 for the apparatus 200 illustrated in FIG. 11. The cross-coupling is below −11.3 dB.

FIG. 12C illustrates the total efficiency for the apparatus 200 illustrated in FIG. 11. The operational bandwidth 100 of the MIMO antenna is from 3.3 GHz to 7.4 GHz.

The following variation can be made to the examples provided. The designs described above may include the following alternative features:
the slots are in the same plane, or in parallel planes, or in planes with different angles;
the open slot can have two, three or more branches;
the closed slot can have one or more branches;
the branches of the slots can be in different angles, from 0 to 180 degrees;
the shape of the slots can be rounded or rectangular;
the slots can be combined to a single open slot;
the feed can be galvanically or capacitively coupled;
the open slot can have different shapes, e.g., L, T, F, U, etc.
the closed slot can have different shapes, e.g., I, J, L, etc.
several antennas can be used in the same electrically conductive rim;
several antennas can be attached so that slots are combined;
the angle between the rim and ground plane can be larger than 0 and smaller than 180 degrees;
resonance frequency of the design can be shifted by changing its dimensions;
matching circuits can be used to improve impedance matching and total efficiency.

The examples described could be used in thin portable devices, e.g., smart phones, smart watches and tablets.

The examples described are particularly useful in relatively small devices accommodating many antennas and possibly being close to human body during normal use.

The examples described with respect to smartphone/mobile/handheld devices, however, the antenna arrangement(s) 2 can be of use in any electronic device which requires wireless communication.

There are many alternative methods of constructing an antenna arrangement 2. For example, and not being limited to, stamped sheet metal, machined metal, printed conductive layers on circuit boards or the like, molded interconnect devices (MID), laser direct structuring (LDS), and other suitable methods of producing antennas for electronic devices.

The metal rim 70 can be encapsulated, either partially or entirely, with a non-conductive dielectric material to form a protective coating and/or an external surface.

Where a structural feature has been described, it may be replaced by means for performing one or more of the functions of the structural feature whether that function or those functions are explicitly or implicitly described.

An operational resonant mode (operational bandwidth) is a frequency range over which an antenna can efficiently operate. An operational resonant mode (operational bandwidth) may be defined as where the return loss S11 of the antenna arrangement 2 is greater than an operational threshold T such as, for example, 3 or 4 dB and where the radiated efficiency (er) is greater than an operational threshold such as for example −3 dB in an efficiency plot. Radiation efficiency is the ratio of the power delivered to the radiation resistance of the antenna (Rrad) to the total power delivered to the antenna: er=(Rrad)/(RL+Rrad), where RL=loss resistance (which covers dissipative losses in the antenna itself). It should be understood that “radiation efficiency” does not include power lost due to poor VSWR (mismatch losses in the matching network which is not part of the antenna as such, but an additional circuit). The “total radiation efficiency” comprises the “radiation efficiency” and power lost due to poor VSWR [in dB]. The efficiency operational threshold could alternatively be expressed in relation to “total radiation efficiency” rather than “radiation efficiency”.

As used here ‘module’ refers to a unit or apparatus that excludes certain parts/components that would be added by an end manufacturer or a user. The rim 70 can be a module. An antenna arrangement 2 can be a module.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. Antenna arrangement, comprising:
a feed; and
an electrically conductive portion that terminates at an edge, wherein the electrically conductive portion comprises a slot comprising:
an elongate first slot-path extending lengthwise from the feed in a first direction; and
an elongate second slot-path extending lengthwise from the feed in a second direction different to the first direction,
wherein the elongate first slot-path extends lengthwise a first distance in the first direction from the feed and then bifurcates into an elongate first bifurcated slot path and an elongate second bifurcated slot path; and
wherein:
the elongate first bifurcated slot path is close-ended and terminates at a first closed end;
the elongate second bifurcated slot path is open-ended and terminates at an open end in the edge; and
the elongate second slot path is close-ended and terminates at a second closed end.

2. An antenna arrangement as claimed in claim 1, wherein the elongate first bifurcated slot path, the elongate second bifurcated slot path, and the elongate second slot path are mutually sized and arranged to provide:
a lower frequency resonance having a lower frequency operational bandwidth;
a higher frequency resonance having a higher frequency operational bandwidth; and
an intermediate frequency resonance having an intermediate frequency operational bandwidth;
wherein the lower frequency operational bandwidth and the higher frequency operational bandwidth are interconnected with the intermediate frequency operational bandwidth to form a combined bandwidth.

3. An antenna arrangement as claimed in claim 2, wherein the feed is a single broadband feed configured to feed across the combined bandwidth.

4. An antenna arrangement as claimed in claim 1, wherein the slot comprises the elongate first slot-path extending lengthwise from the feed in a first direction and the elongate second slot-path extending lengthwise from the feed in a second direction different to the first direction, and
wherein the elongate first slot-path comprises the elongate first bifurcated slot path and the elongate second bifurcated slot path, and
wherein the elongate first bifurcated slot path has a single end that is close-ended, the elongate second bifurcated slot path has a single end that is open-ended, and the elongate second slot path has a single end that is close-ended.

5. An antenna arrangement as claimed in claim 1, wherein a first continuous planar electrically conductive portion defines the elongate first bifurcated slot path, a second continuous planar electrically conductive portion defines the elongate second slot path, and a space between the first continuous planar electrically conductive portion and the second continuous planar electrically conductive portion defines the elongate second bifurcated slot path.

6. An antenna arrangement as claimed in claim 1, wherein the electrically conductive portion is a rim of an apparatus.

7. An antenna arrangement as claimed in claim 6, wherein the rim extends upwardly from a ground plane and the elongate second bifurcated slot path terminates at an open end on an edge or rim furthest from the ground plane.

8. An antenna arrangement as claimed in claim 6, wherein there is no portion of the rim between the elongate first slot path, before bifurcation, and the ground plane.

9. An antenna arrangement as claimed in claim 1, wherein
the elongate first bifurcated slot path comprises an initial portion that extends in the first direction and a terminating portion that extends in a third direction perpendicular to the first direction and terminates at the closed end,
the elongate second bifurcated slot path comprises a terminating portion that extends in the third direction perpendicular to the first direction and terminates the open end, and
the elongate second slot-path comprises a portion extending in the third direction perpendicular to the first direction and a terminating portion that extends in the first direction and terminates at the closed end.

10. An antenna arrangement as claimed in claim 1, wherein the elongate second slot path is positioned and shaped so that the second closed end of the elongate second slot path is positioned adjacent the elongate second bifurcated slot path.

11. An antenna arrangement as claimed in claim 1, wherein the elongate first slot-path has an F-shape and wherein the elongate second slot-path has a J-shape or an L-shape, wherein the F-shape comprises two parallel arms extending perpendicularly from a stem, wherein a first arm is provided with the elongate first bifurcated slot path and a second arm is provided with the elongate second bifurcated slot path, wherein the second arm is positioned between the first arm and the elongate second slot-path having the J-shape or the L-shape.

12. An apparatus, comprising:
an electrically conductive rim; and
at least one antenna arrangement as claimed in claim 1, defined in the electrically conductive rim.

13. An apparatus as claimed in claim 12, wherein the rim has a substantially planar perimeter formed as a rectangle that has 180 degree rotation symmetry, wherein the at least one antenna arrangement is arranged in the rim to satisfy the same 180 degree rotation symmetry.

14. An apparatus as claimed in claim 12, wherein the rim has a spatially distributed array of antenna arrangements wherein the at least one antenna arrangement provides a wideband antenna suitable for multiple-input multiple-output.

15. An electronic device configured for wireless communication comprising the apparatus of claim 12.
